(19) United States
(12) Patent Application Publication
(10) Pub. No.: US 2011/0092287 A1
(43) Pub. Date: Apr. 21, 2011

(54) GAMING PARTICIPANT ATTRIBUTE TAG METHOD AND SYSTEM

(76) Inventor: Paul Maurice SANDERS, Brawley, CA (US)

(21) Appl. No.: 12/580,051

(22) Filed: Oct. 15, 2009

(51) Int. Cl. A63F 13/00

(52) U.S. Cl. 463/35; 463/43; 463/42

(57) ABSTRACT

A multi-participant gaming feature and system is disclosed wherein a player/participant can alter their perception of fellow players/participants, allies and opponents, in accord with a custom menu of identification traits attributable to the tagged player by the tagging player. The altered perception indicator may be as simple as a target always associated with the tagged player, but may also include audio cues, specialized view-thru instruments, changes in heart rate, pre-determined responses to certain actions, flashback viewing of past interaction with that player, behavior modification, and physical characteristic alterations. Such perception alteration features enable participants to make a gaming experience unique to any desired extent relating to their perception of other participants. Defensive modes for such tagging may also be employed to assist those that may have been tagged to comprehend the tagging of themselves and to adjust their game participation accordingly.

### FIELD OF THE INVENTION

This inventive gaming feature and method are related to multi-participant electronic games wherein players interact with displayed game information, i.e., screen or virtual 3D style presentation. Specifically, the invention is related to electronic gaming wherein a participant can create an individualized gaming experience by changing their individual perception of other game participants on a selective and custom basis.

### BACKGROUND OF THE INVENTION

Multi-participant gaming displays that feature generalized locating identifiers for other participants are known. Players can track one another on game radar, i.e., track position/field position, and thusly know one another's whereabouts or relative proximity. In games involving group play, the groups or clans, and thus their respective group identifiers/locators, can be expanded or changed as players are added/deleted owing to game play or elective addition or subtraction of team players and opponents. In addition, it is known for game participants to create and alter physical and performance attributes of themselves, or their game piece, and to alter those attributes as the game proceeds (i.e., faster, slower, weapons, health, energy level, etc.). These attributes are perceptible to other participants and to the participant themselves.

### SUMMARY OF THE INVENTION

The present invention is directed to a gaming feature and system that enables and supports the capability of a gaming participant to alter their perception of fellow players on an individual and selective basis. The altered perception can be achieved in the form of a tagging function that manifests in player perception as a coloration effect or target on a radar indicator in the game or, when actual direct visual perception is occurring from the player's perspective, a changed appearance or sound associated with the tagged player being viewed.

The reason behind the tagging desire can be wholly personal to the current participant. For example, the participant may have had a good or bad past gaming interaction with that player. It may be that a purposeful elimination of the present player occurred in the past and revenge or grudge retaliation by the present player toward the tagged player is the objective. In such case, visual cues and/or audio cues may be employed to alert the player as to the presence of the tagged player. Additional cuing features may be employed as well, including physical manifestations, increasing heart rate, more rapid breathing, altered body language. The perception may, for example, only be enabled or enhanced through a selected viewing mode (game goggles, eye piece, sensory head gear, etc.), wherein other un-tagged players become ghosted and the tagged player is easily seen by motion changes, color, image acuity or sharpness.

As discussed, the tagging may be for any predetermined purpose and is unique as to the relationship between the player doing the tagging and the player being tagged and thusly creates, within a multi-participant gaming environment, a one-off gaming perception for that participant. The following is a brief set of scenarios that may be embarked on in single game experience. One tag may be a friend with whom a positive past gaming experience was shared, highlighted as a reminder, and a desire exists to arrange a return to that collaborative gaming experience. Such a tag may splash that friend with green invisible coloration only apparent through in game goggles, with audio cues (e.g., a pleasing salutation, ring tone) associated with good times. Another tag may be for a poor gamer whose participation results in bad outcomes for other participants nearby. Such a tag might be red with audio cues of bad outcomes (e.g., a breaking glass sound). Another tag could be a grudge from a past gaming or extra-gaming interaction wherein the present player desires a discreet vengeful course of action toward that participant. The tag could create a sparkling aura, etc., with audio cues of creeping revenge that, in the estimation of the present player, match the mood of the tag and goal with respect to that player.

As a defense, knowing that such a tagging feature (i.e., ESP capability) may be present, other participants may equip themselves with an extra-sensory perception feature to alert them as to the potential mal-intent of another participant. Again, the audio/visual perception alterations would be determined by the second participant, likewise altering and rendering their perception of the gaming experience to be their's alone. They might fear everyone, a markedly paranoid perception, and thusly have a high level of potentially predatory feedback thereby significantly altering the “look and feel” of the game as to their perspective.

System hardware requirements to capably fulfill the objectives and features of the perception altering aspect of the present invention include, for example, those disclosed in U.S. Pat. No. 6,767,287, the contents of which are incorporated herein by reference. Such a system would further advantageously use and adopt the features of state-of-the-art Playstation consoles, i.e., PS3.

### BRIEF DESCRIPTION OF THE DRAWINGS

FIG. 1 is a block diagram of a gaming system architecture suitable for embodying the present system and method.

FIG. 2a is a logic diagram showing operation of the system in accord with the present method during game initialization.

FIG. 2b is a logic diagram for a tagging sequence wherein a player tags a fellow player with a perceptible attribute.

FIG. 2c is a logic diagram for a tagging a fellow player previously identified as worthy of a potential tag.

FIG. 2d is a logic diagram relating to a particular type of tagging sequence wherein a grudge style game interaction is initiated.

FIG. 3a is an example of a tag wherein a “friend” is haloed as a tag.

FIG. 3b is an example of a tag wherein a tag is a change in visual acuity.

FIG. 3c is an example of a tag wherein a tag is a coloration feature.

FIG. 3d is an example of a target type tag for a grudge match sequence.

### DETAILED DESCRIPTION OF THE PREFERRED EMBODIMENT

U.S. pending application Ser. No. 12/370,327, filed Feb. 12, 2009, entitled System and Method for Automated Creation of Video Game Highlights, is incorporated herein by reference thereto.

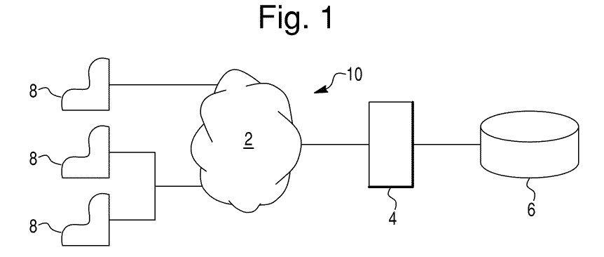

FIG. 1 is a block diagram of a gaming architecture 10 capable of implementing the system and method of the present invention. This system and method can be implemented on various gaming consoles and systems including, for example, the Sony PlayStation 3. Programming techniques for such systems and consoles are known, for example, through resources referenced by those of ordinary skill in the gaming field including Rabin, Steve, Introduction to Game Development (Game Development Series), Charles River Media (June 2005).

Generally, the system 10 includes a plurality of game consoles 8 such as the Sony Playstation console, connected via a network, in this case the Internet 2, to a remote server, or group(s) of servers, 4 which, in turn, are connected to various data storage devices 6. The game server 4 contains information about each participant in the game, their profile, any pseudonyms used by that player, and other such player information as the particular game has been programmed to provide so as to enable cognition of fellow participants and their respective gaming histories. The server also provides stored information for reference, personal memory, only by the current player or 1^{st} participant, presently joining the game. This limited access personal memory information includes past attribute tags employed by this user as to other game participants, and may include an archive of memory trigger video(s) that highlight past experience(s) that the 1^{st} participant has created and maintained with respect to those 2^{nd} participants presently identified by the server as currently playing the game. This 2^{nd} participant player information is updated as game play progresses inasmuch as new players join the game and current players depart the game.

A player in the inventive system can, at any time during their game play, mark a period of game play as significant in the form of a highlight, as described in application Ser. No. 12/370,327, so as to be later recalled as a memory trigger and reviewed as it may relate to an attribute tagging decision relating to another participant. The highlight video may be maintained as a record to share/forward to others in the game as well. A player may alert another player or friend as to the poor game play exhibited by another player or their perceived mal-intent towards other gamers.

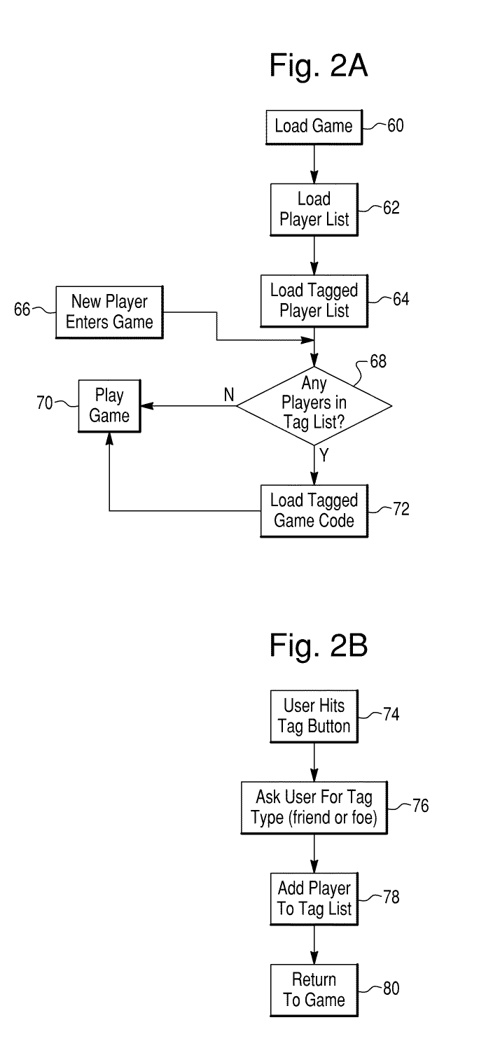

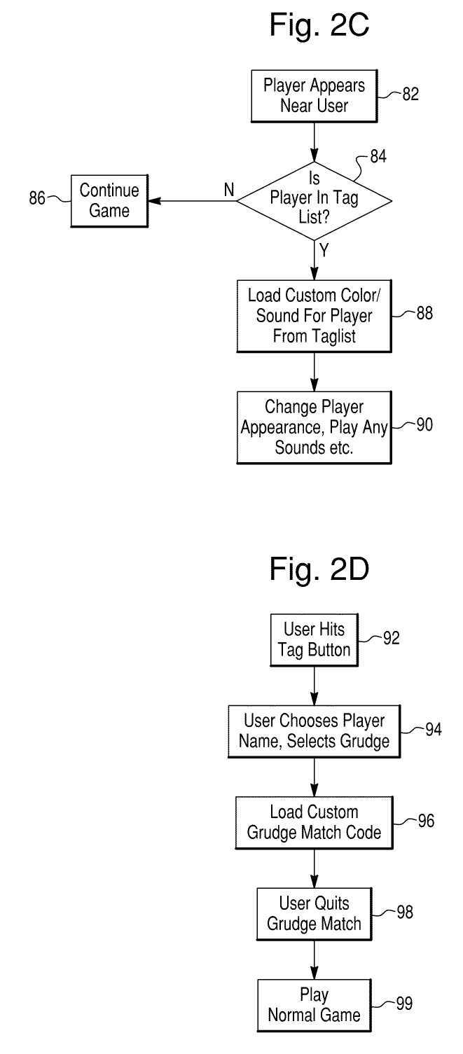

FIG. 2a is a logic diagram demonstrating a basic embodiment of the present system and method and shows game initialization. A player joins the game by loading the game and logging in 60. The player is then able to toggle various functions from the game information screens to indicate who else is present in the game by name, pseudonym, or other identifier, as a Player list 62. The player can also note whether anyone present has been previously tagged or been the subject of an associated highlight video by loading a Tagged Player List 64. If no other present player is noteworthy, the player may proceed to the game 70, spawn, and play. During the game, a visual and or audio indicator will thereafter prompt the player to from time-to-time 66 to check who else is present as others join the game. If these late joining players are “of interest” by virtue of a past tag or memory highlight reel segment, a particular or distinct audio (i.e., jingle or ring tone) or visual indicator may be used as a prompt to enhance the player's awareness of the joining player's status as of interest.

If tags or memories are present, a player can resort to the logic set forth in FIG. 2b where a tag button is toggled 74, a query is set for friend or foe 76, and a new player is added 78 to the tag list, before returning to the game 80. In addition, in accord with FIG. 2c, a player may encounter another player, and not recognize the player nor know that the player is on a prior list, but, none-the-less wish to make a tag on the advice of a friend or other confidant in the game. In such case, when an unfamiliar player appears or is proximate the tagging player, 82, a query 84 can be set to check the Tag List, if Yes, a tag can proceed with selected color and sound 88, and even change their appearance 90 (taller/shorter/fatter/covered in scales/dripping wet/etc.) When satisfied with the tag, return to game play 86 is achieved.

To assist in making a determination to tag another player, the various highlighted gaming segments accumulated from past play may be viewed. If pleasant, a tag reflecting this good outcome may be used. If not pleasant, other suitable tags can be applied. The player can view a list of attributes that can be used as a tag. Game supplied standard attributes or tags can be audio (musical clips, repetitive sounds (i.e., beating drum, breaking glass, JAWS type music with increasing pace in relation to player proximity)) or visual (feature exaggeration, i.e., large head, eyes, mouth, feet, belly, forehead, or color/texture, sweating, panting, coughing, etc.). The tags supplied in the game may by theme specific to the game, i.e., WW II, Knights of the Round Table, WarCraft. Or, if desired, the tag may be customized 56, wherein an audio clip is imported and applied, or a particular feature is photo mapped (i.e., using a sketching feature) onto the perceived view of the tagged player. The tagging player might also determine how they prompt their own use or perception of the tag being applied. Should it be visible at all times and at all distances, only through goggles, or when an ESP (preset for proximity) toggle is depressed or otherwise activated. Once the player is satisfied with the tag, its use and usefulness to them in their enjoyment of the game, play can resume.

A grudge match tagging sequence is similar to the foregoing logic in FIGS. 2a-2c except when the tag button 92 is toggled, a player selects a grudge tag 94 and loads special grudge code 96. This alerts the tagging and tagged player of the vendetta/grudge match. As desired, a person can end the grudge tag 98 and play a normal game 99.

In further embodiments of the invention, an ESP function may be made available to other participants to enable self awareness on their part that they have been tagged by others. This may be accomplished via a “mirror” function whereupon a tagged player can “see” themselves as others do in the game. It may well surprise them at various times when they look in the mirror and comprehend their perception vis-à-vis other players. These ESP capabilities might be earned, stolen, captured, bought, etc. as a part of the game. Or, perhaps only a spy master or other suitable role player (i.e., wizard, or other mentalist) in a game would have the abilities to “know” the tags, i.e., be able to understand or be aware of the true thoughts and motives, of other players. A player might share this information with others, or not, on a selective basis. Likewise the tagger may let those who have been tagged be aware of their status so that a mini-game can be played within the main game, at least as between those who have respectively been made reciprocally aware of their tagged status. These grudge style mini-games may persist between these players at all times, or not, dependent on the desire of the participants.

The tagging function would preferably be controlled by a server resident program. Wherein a player at a console would indicate a desire to tag, the server would acknowledge and accommodate that desire, place the tag and provide code to the console so that the tag could, thereafter, be observed through that console during game play. If a tagger wants to share that tagging information or perception, the server could be instructed to send that same code to another console so as to replicate the perception of the tag.

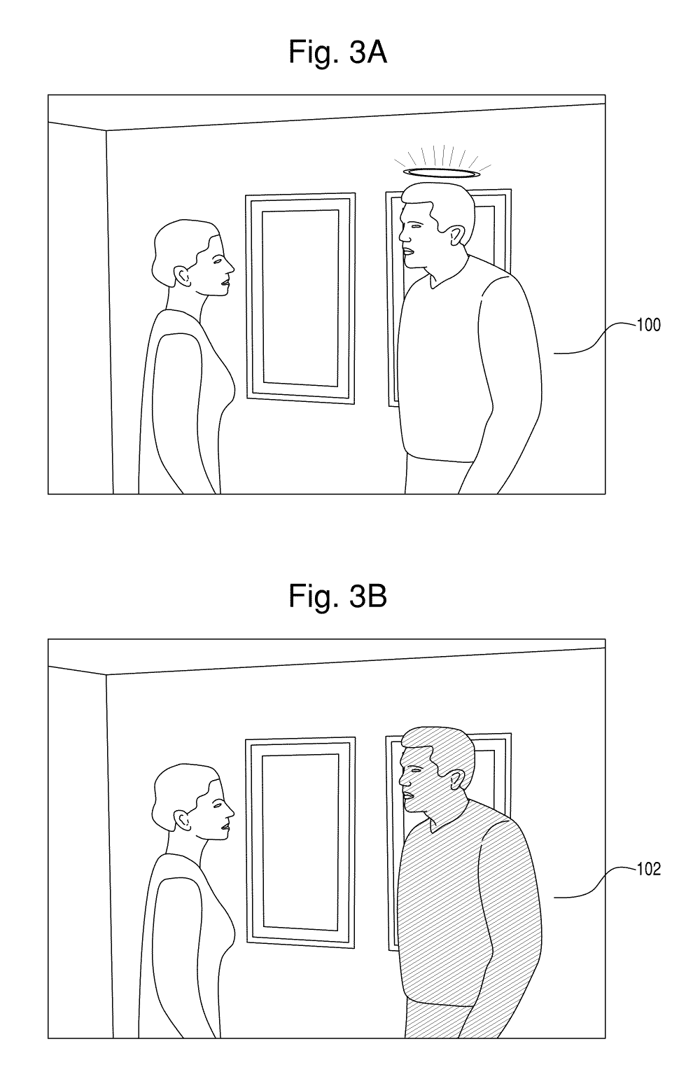

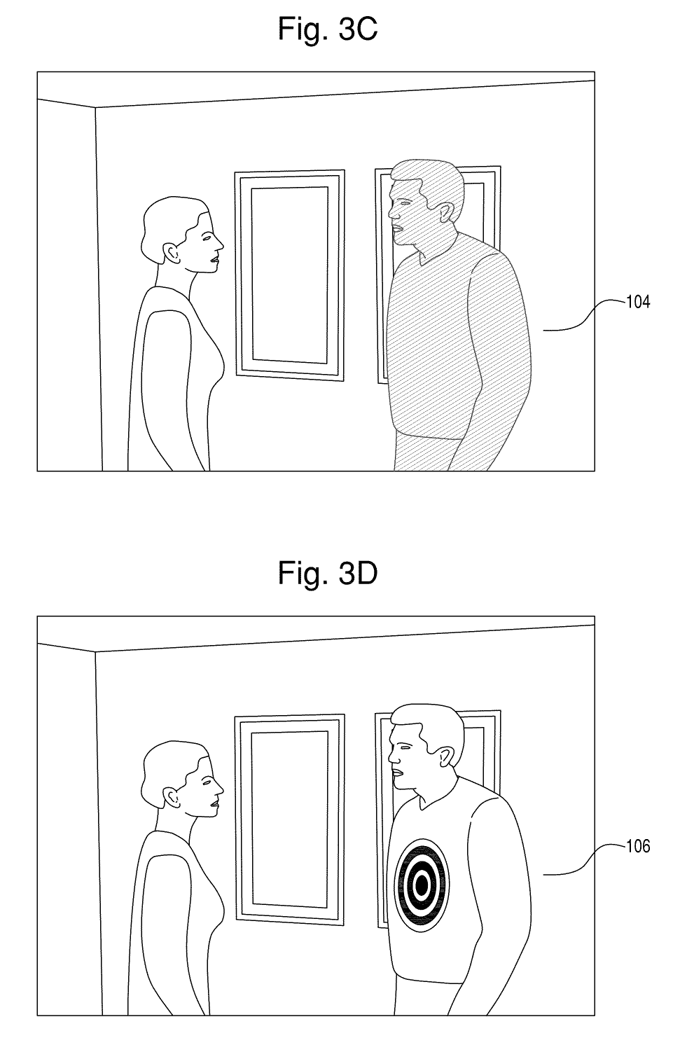

FIGS. 3a-3d show various tags or attributes applied to a gaming figure. Where audio is present, this is shown by cross checking texture lines on the drawing. A tagging feature may include, for example, a Halo 100 as in FIG. 3a. Or, in the alternative an avatar in color 3c (all white, all red, etc.) 104 or focus contrast FIG. 3b 102 with the surroundings on the screen. Or, a target painted on them as a foe 106 as shown in FIG. 3d.

The present invention is not limited to the particular features or to the details of the preferred embodiment specified in the foregoing description. It is therefore understood that upon reading and understanding the specification and claims of this invention, those skilled in the art can make numerous modifications, omissions, changes, and substitutions in the preferred embodiment, in the forms and details of the system and method, and in its operation, and yet fall within the scope of present invention.

1. A method of playing a multi-participant software controlled game on a gaming system including a plurality of data entry game play consoles, a server and a data storage device, connected one to the other via a network, said game including a 1^{st} player and a plurality of 2^{nd} players, comprising the steps of:
entering said 1^{st} player identification information into said electronic gaming system and initializing said game;
determining the identity of said 2^{nd} players in said multi-participant game based on 2^{nd} player identification listing provided to a gaming console of said 1^{st} player by said server;
said 1^{st} player selectively tagging at least one of said 2^{nd} players appearing on said listing with an attribute which, thereafter in game play, is perceptible only to said 1^{st} player;
setting rules controlling perception of said attribute by said 1^{st} player; and,
playing said game in accord with predetermined rules embedded in said game software; wherein,
said attribute is perceivable to said 1^{st} player in accord with rules set by said 1^{st} player.

2. A method as in claim 1, wherein:
said attribute is an audio clip.

3. A method as in claim 1, wherein:
said attribute is visual.

4. A method as in claim 1, wherein:
said rules setting step relies on selective activation of a sensory enhancement capability associated with said 1^{st} player.

5. A method as in claim 4, wherein:
said sensory enhancement is provided by in game goggles.

6. An electronic gaming system for tagging players within said game with attributes perceptible to a 1^{st} participant performing the tagging, said game system comprising:
an electronic storage device for storing an interactive entertainment history of game participation by at least one of said 1^{st} participants and a plurality of 2^{nd} participants who have played simultaneously in the past;
a processor for searching said storage device and sending display information regarding said entertainment history to a game console;
display means associated with said game console for displaying said entertainment history; and,
data entry means associated with said game console for entering tagging selections of said 1^{st} participant with respect to at least one of said 2^{nd} participants, said tagging selections creating an attribute perception, thereafter during game play, on the part of said 1^{st} participant of said at least one 2^{nd} participant that is perceptible exclusively to said 1^{st} participant.

7. A system as in claim 6, wherein:
said entertainment history includes past attributes tagged by said 1^{st} participant as to said 2^{nd} participants.

8. A system as in claim 6, wherein:
said entertainment history includes past attributes tagged by said 1^{st} participant as to said 2^{nd} participants as well as highlight video segments of past game participation between said 1^{st} participant and said 2^{nd} participants.
